(19) United States
(12) Patent Application Publication
(10) Pub. No.: US 2025/0214376 A1
(43) Pub. Date: Jul. 3, 2025

(54) NON-PNEUMATIC TIRE WITH REINFORCING ELEMENTS SPACED INBOARD FROM AN AXIAL EXTENT OF THE TREAD

(71) Applicant: COMPAGNIE GENERALE DES ETABLISSEMENTS MICHELIN, Clermont-Ferrand (FR)

(72) Inventors: Brooks ADAMS, Easley, SC (US); Ronald Hobart THOMPSON, Marietta, SC (US); John DUTY, Mauldin, SC (US); Tony MARCONI, Greenville, SC (US)

(21) Appl. No.: 18/851,551

(22) PCT Filed: Apr. 13, 2022
(86) PCT No.: PCT/US2022/024533

§ 371 Date: Sep. 26, 2024

(51) Int. Cl. B60C 7/10; B60C 7/14

(52) U.S. Cl. CPC B60C 7/102; B60C 7/146

(57) ABSTRACT

A non-pneumatic tire (100) is provided that has a rim (104) with an axis extending therethrough. An annular support (103) extends outward from the rim in a radial direction. A tread (101) is present that has a surface, and a farthest outer axial extent (804) located at a terminal end of the tread in the lateral direction. An annular beam (200) is located between the annular support (103) and the tread (101) in the radial direction. The annular beam (200) has a reinforcement portion (300) that has a plurality of reinforcing elements. The reinforcing element closest to the farthest outer axial extent in the lateral direction is at a width W1 to the farthest outer axial extent in the lateral direction. W1 is at least 8 millimeters.

### STATEMENT REGARDING FEDERALLY SPONSORED RESEARCH OR DEVELOPMENT

This invention was produced in part using funds from a cooperative program sponsored by the U.S. Department of Defense under Cooperative Agreement Award No. HQ0034-15-2-007 to the National Center for Manufacturing Sciences, Inc. dealing with airless tire technology. Accordingly, the Federal government may have certain rights in the invention.

### FIELD OF THE INVENTION

This disclosure relates to non-pneumatic tires (NPTs) for on-road or off-road vehicles (e.g., automobiles, light trucks, and heavy trucks, all-terrain vehicles, zero turn radius lawn mowers, military vehicles). Particularly, it relates to NPTs for off-road vehicles which may require higher speed and load capabilities, along with directional stability over rough terrain that feature improved rut wander performance.

### BACKGROUND

Non-pneumatic tires (NPTs) have advantages over pneumatic tires. NPTs are not pressure vessels, as are pneumatic tires. They cannot fail due to air pressure loss, which is advantageous. Particularly, tension based NPTs have shown merit in off-road usage requiring high speed and high load.

The owner of the present application sells tension based NPTs in several markets, including the Utility Terrain Vehicle (UTV) market. UTVs may be capable of high speed and high load, with such operation often occurring over rough, deformable, off-road terrain. As such, the terrain may have what are called “ruts.” In this context, a “rut” is a deep groove or track that has been created from the passage of one or more off-road vehicles. These ruts may be moderate or quite large in both width and depth. Furthermore, a rut may occur on a straight section of road or on a curved section of road.

“Rut wander” is a term used to describe the tendency of a vehicle to follow or track a pre-existing rut. If a vehicle has pronounced rut wander, the driver of the vehicle may be required to make a considerable effort in steering wheel input to exit the rut trajectory. For this reason, rut wander may be undesirable. However, some vehicles, particularly UTVs, equipped with NPTs have been shown to exhibit rut wander in certain conditions.

NPTs used for UTVs are relatively new, having been introduced into the market within the past 6 years. Rut wander itself is a complex phenomenon and is not well understood. There is a gap, therefore, in both product performance and physical comprehension.

In some respects, it is thought that the on-road tendency known as “wandering” may be similar to off-road rut wander. Wandering is when the vehicle drifts to one side or from side to side during travel which requires the user make constant inputs to the steering wheel for correction. With pneumatic radial tires, on-road wandering has some relationship to a tire's performance in camber thrust. Camber thrust is a lateral force that is developed when a tire is loaded against and rolls on a flat surface that is angled in the lateral direction. In SAE (Society of Automotive Engineers) coordinates, a tire with a positive camber thrust will tend to move down the camber incline, whereas a tire with a negative camber thrust will tend to move up the camber incline. As such, a small positive or even negative camber thrust may be desirable, as the vehicle may tend to climb “up” or out of a groove or rut in a hard surface road.

U.S. Pat. No. 4,836,257, for example, discloses certain tread pattern designs for a pneumatic radial tire that influence camber thrust. Tread designs that result in a camber thrust that tend to force the tire up the camber angle are shown to be better in wandering performance on a hard surface road.

While off-road rut wander may relate to on-road wandering, the mechanisms and complexities have important differences. Furthermore, tension based NPTs develop forces and carry loads much differently than do pneumatic tires. U.S. Pat. No. 7,201,194, owned by the current applicant, discloses details of how a tension-based NPT may carry load. The entire contents of U.S. Pat. No. 7,201,194 are incorporated by reference herein for all purposes. Mechanisms are different than a pneumatic radial tire.

To the inventors' knowledge, no prior art discloses any aspect of camber thrust, wandering, or rut wander of tension-based NPTs. The architectures, materials, and mechanics are different between NPTs and pneumatic tires. Further, off-road rut wander may be different from on-road wandering.

U.S. Pat. No. 9,156,313, owned by the current applicant, does disclose a tension-based annular beam that may produce a variable contact patch pressure. This variation may relate to a transverse crown profile, product thicknesses, and/or material properties. However, no disclosure is given that relates to lateral stiffness, cornering stiffness, or camber thrust in any f the disclosed designs. This patent is directed towards the use of a variable pressure “shear beam” as it may be applied to the crown of a pneumatic tire for the purpose of improving hydroplaning performance of the pneumatic tire. The entire contents of U.S. Pat. No. 9,156,313 are incorporated by reference herein in their entirety for all purposes. As such, this patent has no teaching regarding the current application that is directed to an NPT that exhibits improved rut wander performance. As such, there is a need for better comprehension of rut wander, and for improvement of rut wander performance in tension based NPTs.

### SUMMARY

The present application is generally related to vehicles that use tires. Specifically, this application is especially suited to off-road vehicles that may require high speed and high load, as well as directional stability and control in the presence of pre-existing ruts in the ground contact surface.

According to one aspect of the invention, there is provided a tension based non-pneumatic tire comprising an annular beam, an annular support extending radially inward from the annular beam, and a rim extending radially inward from the annular support. The non-pneumatic tire has a camber thrust stiffness, also called normalized camber stiffness, of no more than +0.1 kg/degree per kg, when measured at 75% of a maximum rated load. In some cases, the camber thrust stiffness may be no more than 0.05 kg/degree per kg, and in yet additional cases it may be no more than 0.0 kg/degree/kg.

According to another aspect of the invention, there is provided a tension based non-pneumatic tire that has an annular beam, an annular support extending radially inward from the annular beam, and a rim extending radially inward from the annular support. A tread portion extends radially outward from the annular beam. A circumference of an outer radial extent of the tire near an axial extent of the tread portion may be at least 50 mm less than a circumference near an axially central tread portion. In various instances this difference may be at least 75 mm, at least 100 mm, and in other cases even greater than these amounts.

According to yet an additional aspect of the invention, there is provided a tension based non-pneumatic tire that features an annular beam, an annular support extending radially inward from the annular beam, and a rim extending radially inward from the annular support. The non-pneumatic tire has a subjective rut wander performance of no less than 3.0 on a scale of 1 to 5.

According to a still further aspect of the invention, there is provided a process for making a tension based non-pneumatic tire that includes an annular beam, an annular support extending radially inward from the annular beam, and a rim extending radially inward from the annular support. The annular beam has a reinforcement portion with a plurality of wraps of a continuous ply. The ply has a portion at an axial extent in which reinforcement is absent for at least one wrap. This portion has a width no less than 8 mm. In other instances, the portion width is no less than 16 mm, and in yet others the width of the portion that lacks the reinforcements is no less than 30 mm. The ply may be formed by a continuous extrusion process, and this process may be concurrent with the forming of the annular beam.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is an embodiment of NPT along with a cylindrical coordinate system defined by the NPT.

FIG. 2 is a tread portion of an NPT shown in perspective view.

FIG. 3 is a cross section view of an annular beam and tread.

FIG. 4A is a cross section view of an annular beam and tread of a Reference Tire.

FIG. 4B is a cross section view of an annular beam and tread of Tire A.

FIG. 4C is a cross section view of an annular beam and tread of Tire C.

FIG. 5 is a perspective view that shows dimensions of an off-road rut that was used in prototype testing.

FIG. 6A is a perspective view of a first example of a test surface that includes ruts for rut wander testing.

FIG. 6B is a perspective view of a second example of a test surface that includes ruts for rut wander testing.

FIG. 7 is a front view of a non-pneumatic tire that illustrates the sign convention for camber thrust.

FIG. 8 is a graph that gives camber thrust measurements for prototype NPTs of FIGS. 4A-4C.

FIG. 9 is a perspective view that shows a finite element model (FEM) of an exemplary NPT.

FIG. 10A is a front view of a portion of Tire A that shows a deformed geometry of the tire under load.

FIG. 10B is a front view of a portion of Tire C that shows a deformed geometry of the tire under load.

FIG. 11A gives FEM predictions for contact patch shapes of loaded Tire A.

FIG. 11B give FEM predictions for contact patch shapes of loaded Tire C.

FIG. 12 is a graph that gives FEM predictions for loads per rib during loading analyses.

FIG. 13 is a partial perspective view that shows FEM geometry and a reference axis used for plotting results.

FIG. 14 is a graph that gives FEM results for rubber matrix strain during loading.

FIG. 15 is a perspective view in cross section that shows an NPT annular beam with a reinforcement portion with reinforcement elements.

FIG. 16 is a perspective view in cross section that shows an NPT with another configuration of a reinforcement portion with reinforcement elements.

FIG. 17 is a perspective view of a reinforcement ply that may be circumferentially wrapped when used in an annular beam.

FIG. 18 is a perspective view of a reinforcement ply without reinforcement elements near the axial extents of the ply.

FIG. 19 is a perspective view that shows a cross section of an annular beam with reinforcement elements that may be near the beam axial extents in some ply layers and absent in others.

FIG. 20 is a perspective view that shows a cross section of an annular beam having a shoulder tread portion comprising grooves oriented in the axial direction.

Repeat use of reference characters in the present specification and drawings is intended to represent the same or analogous features or elements of the invention.

### DEFINITION OF TERMS

The following terms are defined as follows for this disclosure, with material properties referring to those at ambient temperature, unless otherwise noted:

When referring to a reinforcement cord or cable, “modulus” means Young's tensile modulus of elasticity measured per ASTM D2969. The tensile modulus may be calculated as the secant modulus at a strain of 0.5%.

When referring to rubber, “shear modulus” refers to the dynamic shear modulus as measured according to ASTM D5992-96 (2018), at 10 HZ, 23C, and 2% strain. When referring to rubber, “extension modulus” refers to a Young's modulus measured according to ASTM D412.

“Design Load” of a tire is a usual and expected operating load of the tire.

“Max Load” of the tire is the maximum rated operating load of the tire.

“Camber angle” is an inclination angle of an R-θ plane of the tire, according to SAE conventions.

“Camber thrust” is an axial force generated by the tire rolling on a flat surface while at a camber angle.

“Camber stiffness” is a change in the camber thrust per camber angle degree.

“Normalized camber stiffness” is the camber stiffness divided by a vertical load applied to the tire. Once normalized, this number is also referred to as the “camber stiffness” herein.

“Rut wander” is the rut wander performance defined herein.

### DETAILED DESCRIPTION OF EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

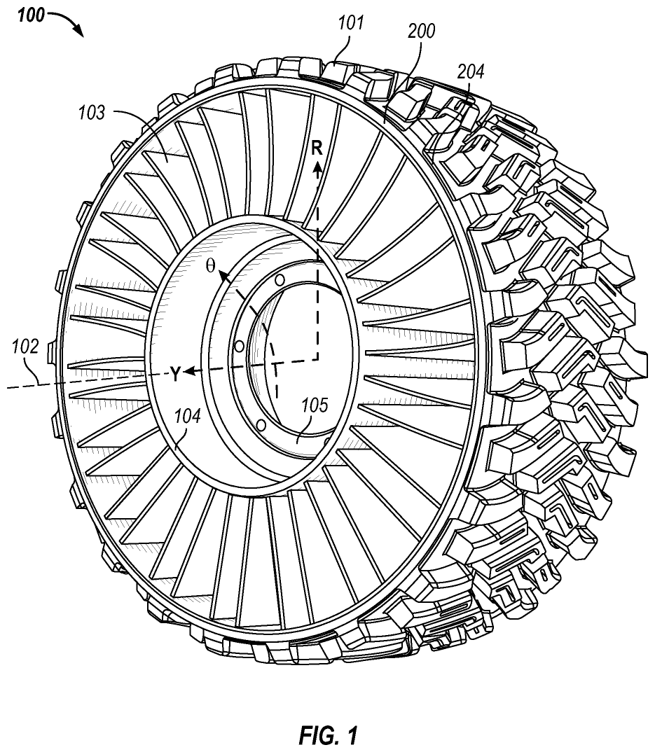

FIG. 1 shows an exemplary example of a tension-based NPT 100. The NPT comprises an annular beam 200. The annular beam 200 has on it a tread portion 101 which comprises a tread pattern. The annular beam 200 is supported by an annular support 103 which is disposed radially inward from the annular beam 200. A rim 104 extends radially inward from the annular support 103. A central wheel flange 105 may extend radially inward from the rim 104 and may be configured to be attached to a vehicle.

The NPT describes a cylindrical coordinate system. “R” is the radial direction; “θ” is the circumferential direction; “Y” is the axial direction. A related cartesian coordinate system may be defined: when the NPT rolls on a flat contact surface, the NPT moves in the “X” longitudinal direction; “Y” is the lateral direction; “Z” is vertical. An axis 102 of the tire 100 extends through its radial center and extends in the lateral direction Y such that the lateral direction Y is parallel to the axis 102. The radial direction R extends at a 90 degree angle to the axis 102.

The annular support 103 may comprise radially oriented spokes 103, and other structures besides spokes 103 are possible. When the NPT 100 is loaded, the annular support 103 develops tension forces. For this reason, the NPT 100 may be referred to as a “tension based” NPT 100. The spokes 103 may extend freely (i.e., without attaching or otherwise intersecting other material of the NPT 100) from the annular support 103 towards the rim 104. As disclosed in U.S. Pat. No. 11,179,969, owned by the current applicant, and incorporated by reference in its entirety for all purposes, an exemplary form of construction is illustrated.

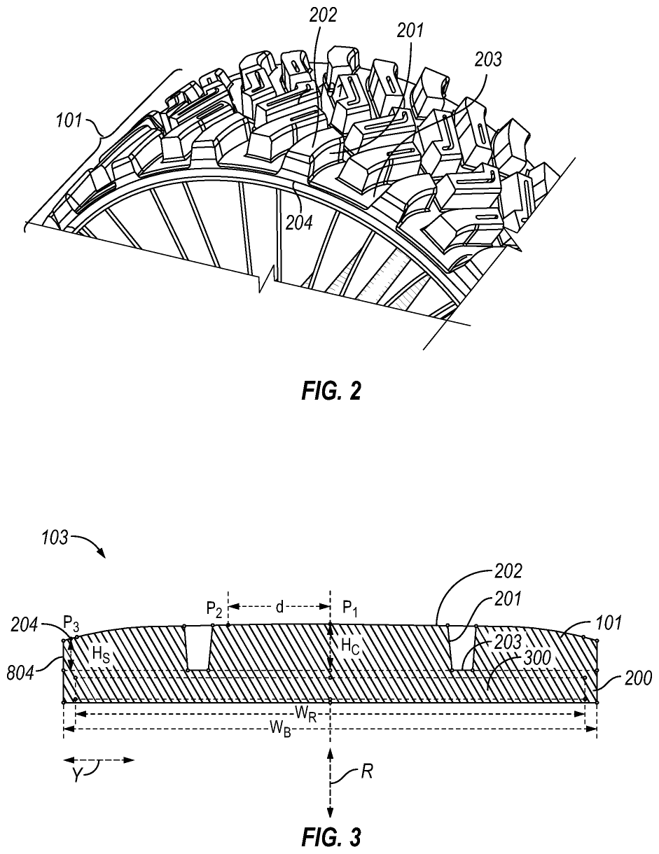

The tread portion 101 is further illustrated in FIG. 2. The tread portion 101 may comprise tread blocks 201, having a surface 202 on the outer radial extent. This surface 202 may contact the ground. The tread portion 101 may have a bottom surface 203 which defines an inner radial extent for the tread blocks 201.

FIG. 3 shows a cross section of an annular beam 200 with a tread portion 101. WB is an annular beam width in the axial direction Y. The tread block 201 extends radially from the surface 202 which is on an outer radial surface 202 to the bottom surface 203 which is an inner radial surface 203. A reinforcement portion 300 is disposed radially inward from surface 203. The reinforcement portion 300 may comprise reinforcing elements extending in the circumferential direction θ, such as those disclosed in PCT/US2021/030302, owned by the current applicant and incorporated by reference herein in its entirety for all purposes. The reinforcement portion 300 has an overall width W_{R} in the lateral direction Y. A tread depth at an axially central point P₁ is H_{C} and is a depth that extends in the radial direction R. A tread depth at point P₃ at an axial extent 204 is H_{S}. A point P₂ is located on surface 202 at a distance d from the point P₁ in the Axial direction Y.

The axial extent 204 is the farthest outboard and inboard extent of the tread portion 101 in the lateral direction Y. The axial extent 204 could also be described as being the part of the tread portion 101 farthest from the point P₁ in the lateral direction Y. The axial extent 204 could also be described as being the point of the tread portion 101 farthest from the center of the tread portion 101 in the lateral direction Y. However, it is to be understood that as used herein, the term “axial extent” 204 includes not only the location of the tread portion 101 farthest from the center/point P1 in the axial direction Y, but also the tread portion 101 up to and including 5 millimeters inboard in the axial direction Y. As such, the axial extent 204 is a 5 millimeter range of the tread portion 101 at the extreme inboard, and at the extreme outboard, end of the tread portion 101 in the lateral direction Y. The point P₃ is located at the axial extent 204 at any location within this 5 millimeter range.

As shown in FIG. 1, the annular beam 200 is revolved around the axis of rotation which extends through the center of the NPT 100 in the axial direction Y. A circumference at P₁ is P_{1CIR}. A circumference at P₂ is P_{2CIR}; and a circumference at P₃ is P_{3CIR}. The annular beam 200 of FIG. 3 is illustrated as having 3 ribs with 2 circumferential grooves for simplification of illustration only. Surfaces 202 and 203 may serve to define the radial extents of a complex tread pattern as shown in FIGS. 1 and 2.

The annular beam 200 of FIG. 3 is symmetric with respect to an axis that extends through point P₁ in the radial direction R. However, the scope of various embodiments also included herein also applies to architectures and designs which are asymmetric.

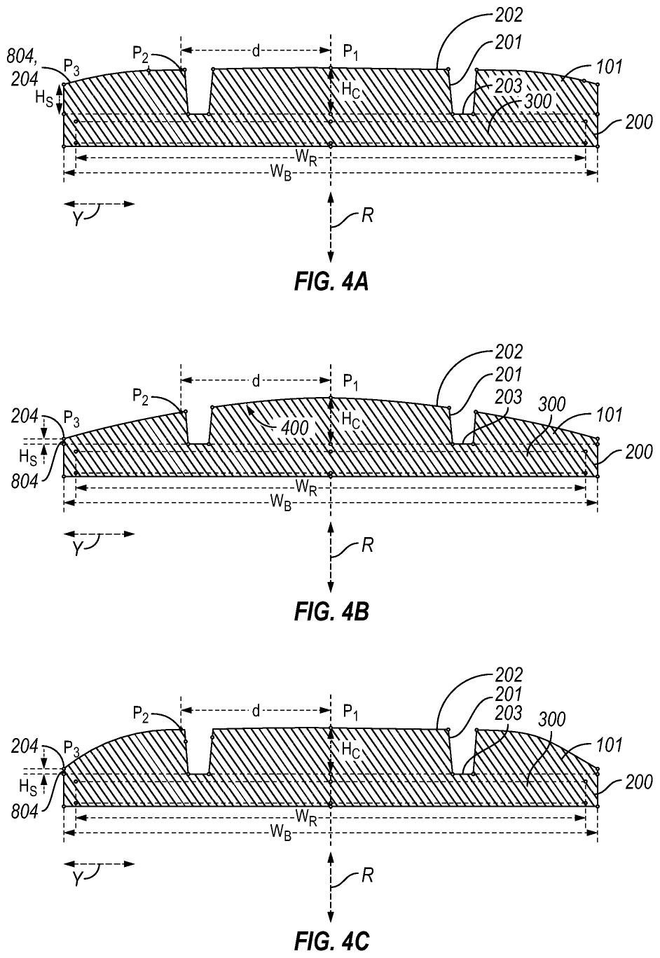

FIGS. 4A, 4B and 4C show cross sections of three NPTs 100 that were reduced to practice in the dimension 26×9−14. In this nomenclature, the NPT 100 outer diameter is 26″; the width is 9″; and the equivalent rim size is 14″. Each of these NPTs 100 are symmetric with respect to an axis that extends through point P₁ in the radial direction R.

The three NPTs 100 each have the same reinforcement portion 300, comprising reinforcing elements that extend circumferentially around the annular beam 200. Width W_{B}=210 mm was identical for each tire as well.

Each NPT 100 in FIGS. 4A-4C has a unique outer surface 202, thereby changing the tread depth, particularly the difference in tread depth at different positions across the tread width (in millimeters):

TABLE 1

| | REFERENCE | | |
|---|---|---|---|
| | (= prior art) | NPT A | NPT C |
| H_{C} | 18 | 18 | 18 |
| H_{S} | 11 | 1 | 1 |
| d | 35 | 35 | 35 |
| P_{1CIR} | 2055 | 2055 | 2055 |
| P_{2CIR} | 2055 | 2042 | 2055 |
| P_{3CIR} | 2011 | 1948 | 1948 |
| W_{B} | 210 | 210 | 210 |
| W_{R} | 200 | 200 | 200 |

Tire NPT A differs from the Reference in that surface 202 is defined by an arc with a transverse radius 400 that is 300 mm. Other measurements change accordingly. NPT C is like the Reference in that surface 202 comprises a flat (cylindrical) section at the axial central portion that is a total of 140 mm in axial width in the lateral direction Y. As such, P_{2CIR}=P_{1CIR} and d=70 mm. Tire NPT C is different from the Reference Tire in that P_{3CIR}=1948 mm instead of 2011 mm. As such, H_{S}=1 for Tire NPT C. The distance d is 35 millimeters, but can be at least 35 millimeters, at least 45 millimeters, at least 55 millimeters, or at least 65 millimeters in accordance with other exemplary embodiments.

The tire 100 in FIG. 4C has a flat surface 202 at the axially central point P₁, and this flat surface has the same circumference about the axis 102 along a portion of the width of the tread 101 in the lateral direction Y. The length of this flat section of the surface 202 may be at least 50% of the length of the annular beam width W_{B}, and in other cases may be at least 75% of the length of the annular beam width W_{B}.

The three NPTs 100 shown in FIGS. 4A-4C were constructed and tested in machine tests and off-road tests. Machine tests included measurements for camber thrust and camber stiffness at different loads. Off road tests included subjective rankings for rut wander. These tests and the test results will now be described in detail.

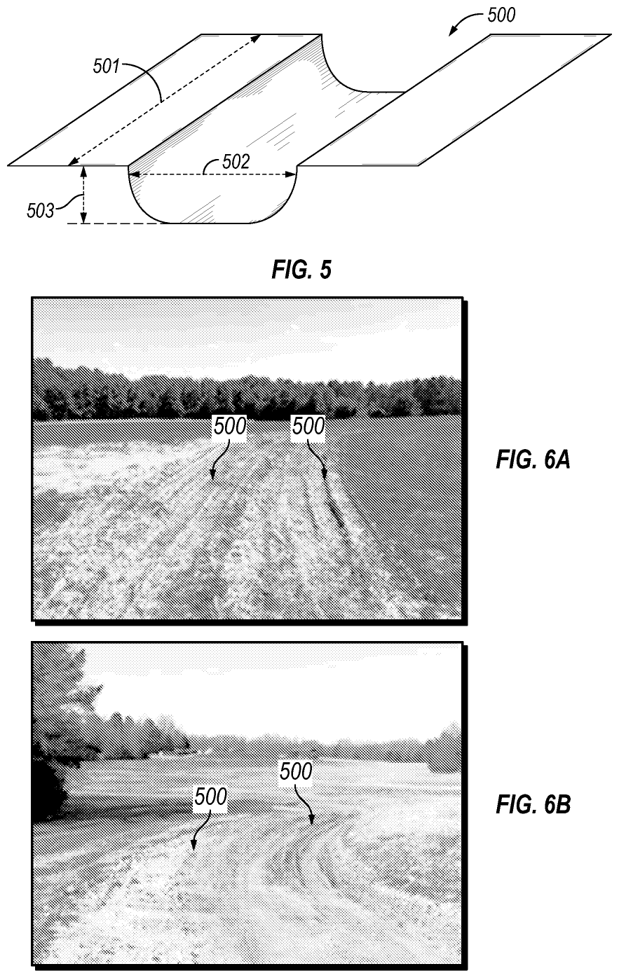

Off road rut wander test description is as follows:
Vehicle: 2014 Honda® Pioneer® 700, with driver and ½ tank of gas.
Speed: 55 kph
Surface: hard packed clay and hard packed gravel
2 wheel drive and 4 wheel drive evaluations
Weather: calm winds, 18C to 26C temperature
Rut 500 description: rut geometry is shown in FIG. 5. Multiple ruts 500 were constructed and used during vehicle performance evaluation.
Methodology: Driver enters rut area at target speed, then positions the vehicle such that one or both front NPT 100 enter a rut 500. The driver then gauges the ease with which a steering input can guide the vehicle out of the rut 500 trajectory.
Scale: 1-5, with a “1” being extremely bad performance and a “5” being excellent performance. The absolute ranking is not as important as the relative ranking.

Examples of two off-road surfaces used in evaluating rut wander are given in the photographs provided in FIG. 6.

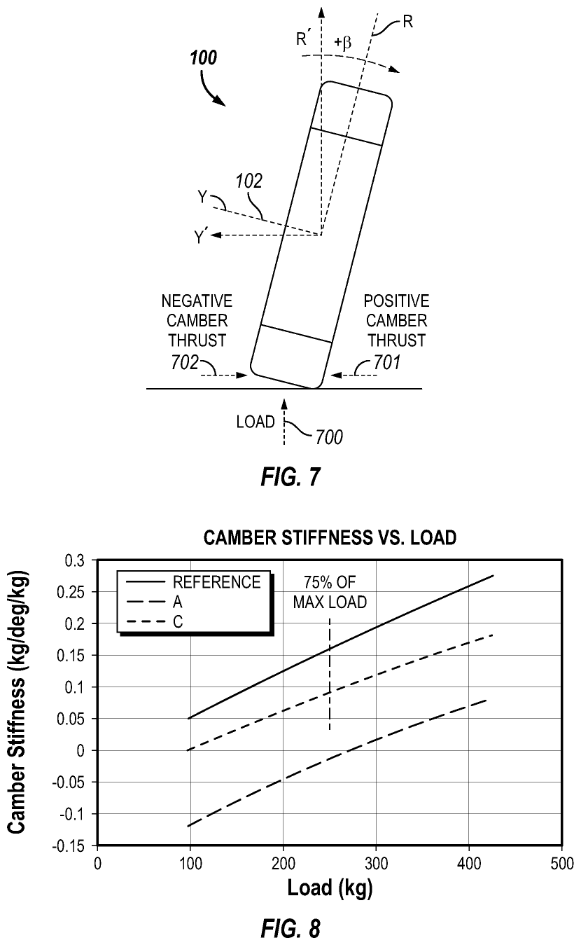

In addition to subjective off-road rut wander, the NPTs 100 were tested in objective machine tests on an MTS Flat Track machine, according to the test method defined in the publication “Michelin® Indoor Characterization for Handling Applied to Mathematical Formulae”, by Jérémy Buisson, Aachener Kolloquium Fahrzeug- and Motorentechnik, 2006. This test can be used to calculate camber stiffness as defined herein. The normalized camber stiffness can be obtained using this camber stiffness as described herein. For convenience, FIG. 7 gives the coordinate system for camber angle and camber force. In this test, the tire 100 is loaded to a required vertical force at a speed of 80 kph, with zero slip angle. The lateral force is measured. Then, a positive camber angle is added. The lateral force is measured. This is repeated for multiple camber angles, over a range of vertical loads. The results can be processed to give a camber thrust and stiffness as functions of load.

From FIG. 7, a positive camber angle +β may generate a positive camber thrust 701. If the tire 100 is loaded on a surface that is cambered (like the side of a rut 500), the camber thrust may tend to guide or drive the tire 100 further into the rut 500. On the other hand, if a positive camber angle +B generates a negative camber thrust 702, the camber thrust may tend to help the tire 100 to climb up out of the rut 500. The radial direction to surface R′ is a line that is a surface normal to the ground upon which the tire 100 rests, and the radial direction R of the tire 100 is oriented at a positive camber angle +β to the radial direction to surface R′. In a similar manner, the axial direction to surface Y′ is a line parallel to the ground upon which the tire 100 rests, and the axial direction to surface Y′ is oriented at the same magnitude of angle +B to the axial direction Y. The radial direction to surface R′ is oriented at a 90 degree angle to the axial direction to surface Y′. The axis 102 is oriented at the same magnitude of angle β to the axial direction to surface Y′.

Therefore, while the mechanics of rut wander are more complex than simple camber thrust, a large positive camber thrust stiffness for a positive camber angle may contribute to a poor rut wander performance. On the other hand, a negative or less positive camber thrust may contribute to an improved rut wander performance.

Camber stiffness measurements of the three NPTs 100 are given in FIG. 8. Camber stiffness was calculated by taking the difference in camber thrust between a +3 degree camber angle β and a 0 degree camber angle β, then dividing by 3. This gives camber stiffness in kg of camber thrust per positive degree of camber. As used herein the camber stiffness may be measured by using this 3 degree range. This value is then normalized by dividing by the load. The camber stiffness is then expressed as kg/degree per kg of load. In this manner, one can better compare the relative camber stiffness of different sized tires with different load ratings.

An example of calculating the camber stiffness will now be described. For a particular tire, for example the Reference tire, the camber thrust at +3 degrees camber angle β was measured to be 150 kg, and the camber thrust of the same Reference tire at +0 degrees camber angle β was measured to be 25 kg. The difference is 150 kg-25 kg=125 kg. The difference divided by 3 is 125 kg/3=41.66 kg/degree. The particular load of interest is 250 kg and this number is used to normalize the value such that (41.66 kg/degree)/250 kg=0.16 kg/degree/kg. This value of 0.16 kg/degree/kg is the camber stiffness, or normalized camber stiffness, of the Reference tire at 250 kg. These numbers can be rerun using different loads of interest to generate the plot shown in FIG. 8.

The reference tire had positive camber stiffness across all loads. Functionally, this means that the reference NPT 100 generated a positive change in lateral force for a positive change in camber angle, regardless of the load. Tire A had much lower camber stiffness, with values being negative at loads below 75% of the maximum rated load for this NPT (325 kg). Tire C was about halfway between the Reference and Tire A.

75% of the max load represents an approximate maximum load one could expect on the front axle of a UTV in the class of the Honda® Pioneer®. Since the front axle plays a dominate role in rut wander, this is the load considered for comparing tire 100 performance.

One way to obtain camber thrust, and hence establish camber stiffness, of a tire 100 is to angle the axle of the tire 100 onto which the tire 100 is mounted. The axis 102 can be angled to the axial direction to surface Y′ such that the axis 102 is not parallel to the axial direction to surface Y′ to yield either a positive or negative camber thrust.

Measured camber stiffness and subjective rut wander results are provided below.

TABLE 2

| | Camber | | |
|---|---|---|---|
| | stiffness at | Rut | |
| | 250 kg (kg/ | wander | Subjective rut wander |
| | deg/kg) | rating | comments |
| Reference | 0.16 | 2.5 | Front tires 100 are pulled into |
| | | | ruts 500, feels like I am along |
| | | | for the ride. |
| Tire A | −0.02 | 3.25 | Lateral forces of rut wander |
| | | | are reduced, easier to climb |
| | | | out of rut 500, but rut wander |
| | | | still exists. |
| Tire C | 0.08 | 3.75 | Noticeable improvement, less |
| | | | sensitivity to deep ruts. Best |
| | | | feel of all letters. Improvement |
| | | | is large enough to be felt by |
| | | | average consumer. |

Compared to the reference, both A and C improved in rut wander subjective performance, and both had reduced camber stiffness. However, NPT A 100 had the lowest camber stiffness yet was worse in subjective rut wander than NPT C 100. This was a surprising result, indicating that the rut wander performance was not explained by camber stiffness alone. This will be discussed in more detail below.

The applicant has developed a tire endurance test that has been shown to correlate to real-world performance for vehicles such as the Honda® Pioneer®. The test includes continuous running at a prescribed load and speed that relate to the maximum rated load and speed. The three NPTs 100 tested in camber thrust and rut wander were tested in endurance. Results are given below.

TABLE 3

| Tire | Relative Endurance Performance |
|---|---|
| Reference | 100% = test completion w/o failure |
| A | 16% |
| C | 100% |

These results were surprising, yet also quite positive. Tire C 100 successfully completed the endurance test, yet also provided the best subjective rut wander score. This led the inventors to further study, as the results were unexpected.

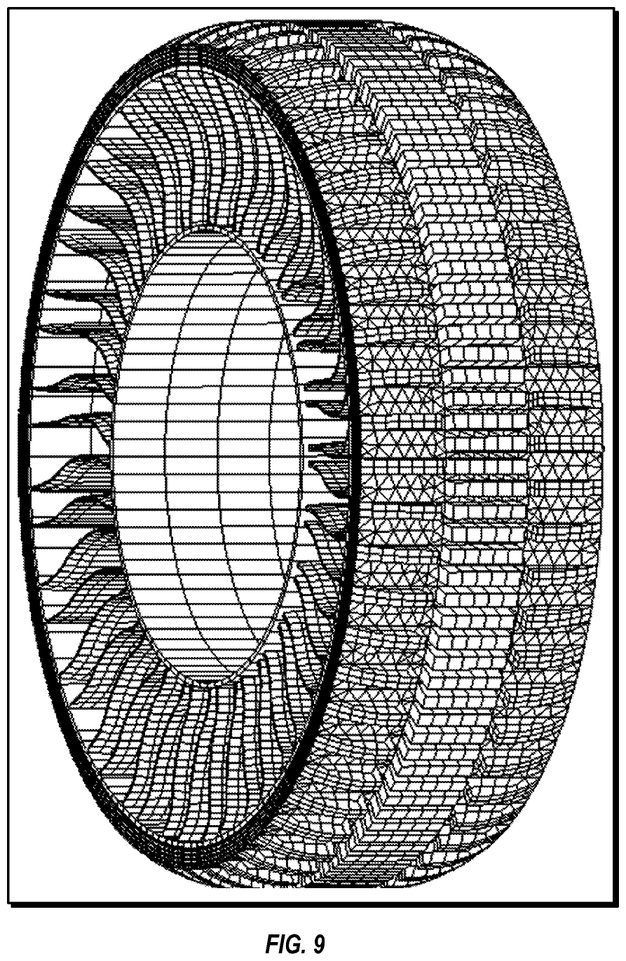

Tires A and C were analyzed using the Finite Element Method (FEM). Abaqus® software was used. For simplicity, a simplified tread pattern was used that approximated the actual tread. An example FEM of Tire C 100 is provided in FIG. 9.

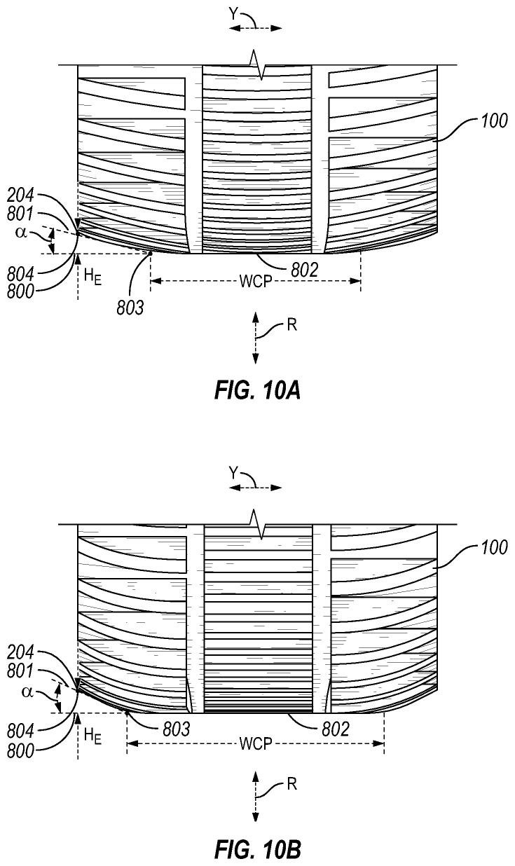

The FEM included complex aspects of NPT 100 behavior. Applicants are well skilled in this area, as disclosed in prior art such as PCT/US2021/030302, previously referenced. Complex modeling practices that correlate well with empirical measurements of actual tires were used in the representation of cord-rubber composite portion. Non-linear geometry and material behavior were also modeled using state of the art techniques. FEM results are provided in FIGS. 10-14.

FIG. 10 shows deformed geometries in which FIG. 10A is for Tire A and in which FIG. 10B is for Tire C, when loaded to 325 kg. This load is a rated load for a current tension-based NPT in the market in the dimension 26×9−14. From these results, the Applicants have identified aspects of the design of Tire C that may explain the advantage in rut wander compared to Tire A. Specifically, a relatively large angle α may improve rut wander, as it provides a gripping surface against a side of a rut 500. This type of mechanical interaction is not represented in an objective measure of camber stiffness on a flat, hard surface. α is defined as an angle between a first line 800 extending from a flat contact patch 802 in the axial direction Y to a second line 801. Second line 801 is between a farthest lateral extent 803 of a contact patch 802 in the axial direction Y and a farthest outer axial extent 804 of the tread. The second line 801 may be completely straight even though the tread 101 that extends from the farthest lateral extent 803 to the farthest outer axial extent 804 is not straight, or this portion of the tread 101 could be straight in other embodiments. The farthest outer axial extent 804 is the portion of the tread 101 located at a terminal end of the tread 101 in the lateral direction Y.

Additionally, the distance between the farthest outer axial extent 804 in the lateral direction Y and the first line 800 in the Radial direction R, HE, may also play a role in rut wander. A larger HE may enable the tire 100 to climb out of a rut 500 more easily by increasing the gripping surface, with less driver steering input required. As the tire 100 begins to climb out of a rut 500, it will carry proportionally more load. Therefore, instead of 75%, 100% of a rated load may be appropriate as a load at which to measure HE.

A large a and a large HE may combine to further optimize off-road rut wander.

Further work by the Applicants has determined that, when loaded to a maximum rated load, α should be no less than 17 degrees; in other cases, no less than 21 degrees; and in other cases, no less than 25 degrees.

Further work by the Applicants has determined that HE should be no less than 12 mm; in other cases, no less than 16 mm; and in other cases, no less than 20 mm, when the tire is loaded to a maximum rated load.

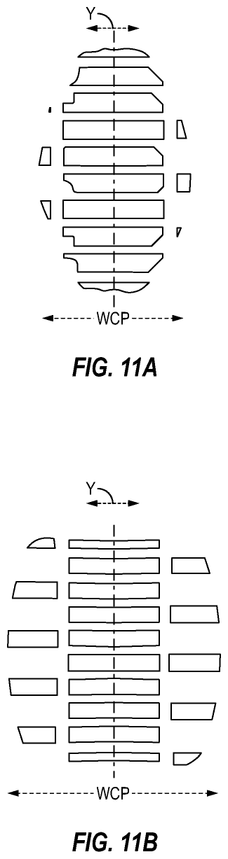

FIG. 11 shows a contact patch 802 for Tire A in FIG. 11A and for Tire C in FIG. 11B at 325 kg. Tire A has a footprint that is almost exclusively on the center rib. The contact width W_{CP}=130 mm in the lateral direction Y, whereas the annular beam width is 210 mm in the lateral direction Y. Therefore, the contact patch 802 occurs on 61% of the tread width. Tire C has a contact patch 802 that has W_{cp}=180 mm, which is 86% of the annular beam width. Tire A has a slightly longer contact width W_{cp} than Tire C.

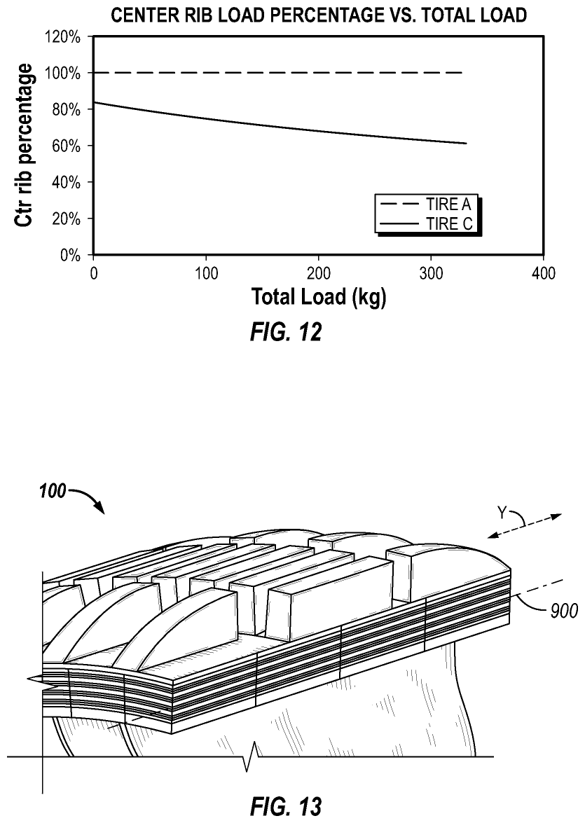

The percentage of load carried by the center rib is given in FIG. 12 for both tires 100. The center rib carries all the load for Tire A, even up to the rated load of the tire. For Tire C, the center rib carries only 60% of the load at the rated load of 325 kg.

Those skilled in the art of tire design may realize that Tire A will develop a much larger stress in the center rib than C. This larger stress will produce higher strain and higher temperature as the tire rolls. This may explain the improved endurance performance of Tire C compared to Tire A.

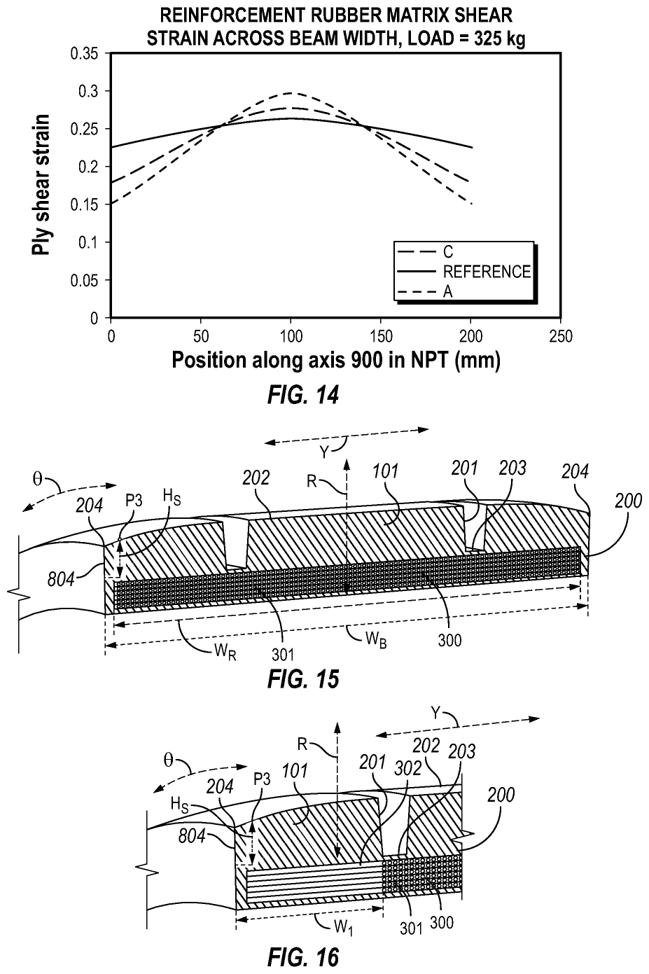

Prior art of the current applicant has disclosed that the rubber matrix in the reinforcement region develops a shear strain. This is especially true when reinforcement elements are oriented in a circumferential direction, as disclosed in U.S. Pat. No. 7,650,919 B2, the contents of which are incorporated by reference herein in their entirety for all purposes. FIG. 13 shows a reference axis 900 passing through the reinforcement region of Tire C in the Axial Direction Y. The reinforcement region comprises circumferential reinforcements. The shear strain developed at the rated load of 325 kg across the width at the reference axis 900 is shown in FIG. 14 for Tires A and C, as well as the Reference tire. The X coordinate on the graph in FIG. 14 is the particular position along the reference axis 900.

Compared to the reference tire, Tire C develops moderately higher strain at the center of the reinforcement region, and lower strain at the edges. This is because the shoulder region of Tire C is rounder than the Reference, and C therefore carries more load in the center. Tire A develops even higher strains in the center and lower strains at the edges. Therefore, compared to C, A will have higher temperatures in the center due to higher strains in the reinforcement matrix. This negative effect may add to the negative effect mentioned earlier, due to the increased contact stresses in the center portion of Tire A.

Additional work by the Applicants has shown that the improved performance of Tire C compared to A may be due to the flat (cylindrical) profile at the tread 101 center. A transverse crown radius in this portion of the outer tread 101 profile may be much larger than an outer radius of the tire 100, as much as 4 times the tire 100 outer radius or even more. The width of this flat center portion may be a significant percentage of the total tread 101 width.

Work by the Applicants has determined that a width of a central flat section of a tread outer surface 202 may be no less than 50% of the annular beam 200 width; in other cases, no less than 70%, and in other cases, even more.

For purposes of explanation, it may be convenient to express this specification using the variables disclosed in FIG. 3 and Table 1. Work by the Applicants has determined that a circumference of an outer radial extent of a tread 101 near an axially central portion may be constant over an axial width that may be no less than 50% of the width of the annular beam 200; in other cases, no less than 70%, and in other cases, even more.

Tire A did not have a flat section in the axial center portion of the outer tread 101 profile, and its endurance performance was poor. However, it did have better rut wander results than the reference and much lower camber thrust. Additional work by the Applicants has determined that this improvement came primarily from the increased circumference near the tread 101 axial center compared to the tread 101 axial extent. To improve rut wander performance, in some cases, a circumference near an axial central portion of an outer radial extent of a tread 101 may be no less than 50 mm larger than a circumference near an axial radial extent; in other cases, no less than 75 mm larger; in other cases, no less than 100 mm larger; and it other cases, even more.

For achieving good rut wander and endurance characteristics, it may be useful to combine the specifications listed above. For example, like Tire C, a circumference at an axial center may be significantly larger than a circumference near an axial extent, and the center circumference may be constant over a tread 101 center portion width that is a significant percentage of a width of the annular beam 200.

An example of an NPT 100 annular beam 200 cross section is shown in FIG. 15. The reinforcement portion 300 comprises reinforcing elements 301 that extend in the circumferential direction Θ. These elements 301 may be metallic cables or composite fibers of high tensile modulus or other suitable material. In this example, the reinforcing elements 301 extend to axial extents 204 of the reinforcing portion 300 in the axial direction Y so as to be at the farthest axial positions in the axial direction Y

FIG. 16 shows an exemplary NPT 100 according to the present disclosure. Here, reinforcing elements 301 may not extend to the axial extents 204. Ply portions 302 include sections that do not have reinforcing elements 301 and are at the axial extents 204 and/or are closer to the axial extents 204 than are the portions of the ply portions 302 that include the reinforcing elements 301. The width W1 is a distance from the farthest axial extent 804 of the tread 101 to the closest reinforcing element 301 in the lateral direction Y. In some instances, the width W₁ is at least 8 millimeters. In other instances, the width W₁ is at least 16 millimeters. In other embodiments, the width W₁ is at least 20 millimeters, at least 25 millimeters, at least 30 millimeters, at least 9 millimeters, at least 12 millimeters, at least 14 millimeters, or at least 10 millimeters.

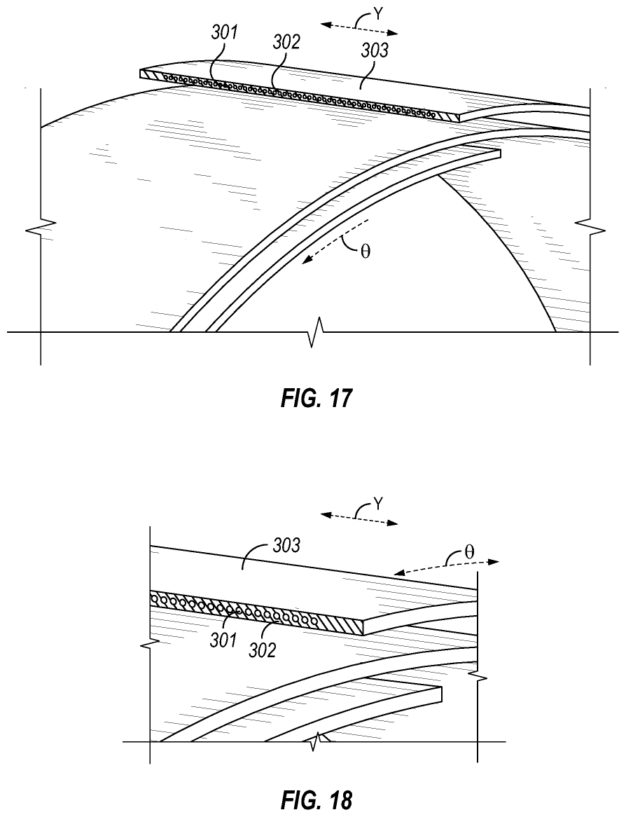

The reinforcing portion 300 may be formed by a ply 303, shown in FIG. 17. The reinforcing portion 300 may comprise a plurality of circumferential wraps of ply 303. As illustrated in FIG. 18, ply 303 may comprise reinforcing elements 301 that are not present near the axial extent of the ply portion 302 such that a width W₁ without the reinforcing elements 301 is present outboard of the reinforcing elements 301 in the axial direction Y that extends to the farthest outer axial extent 804 when incorporated into the tire 100. Further, a single reinforcement portion 300 may be formed in a continuous extrusion process to make up the reinforcement portion 300. This process may occur immediately before, and in some case concurrent with, the wrapping of the ply 303 to form the reinforcement portion 300.

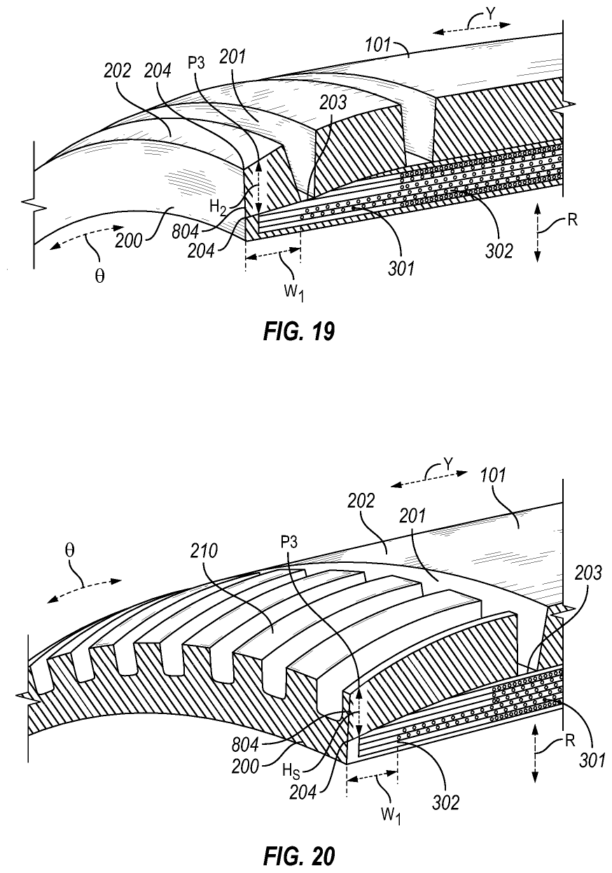

FIG. 19 shows another exemplary embodiment of a cross section of an annular beam 200. Here, reinforcing elements 301 extend closer to an axial extent 204 for one or more ply portions 302 than for other ones of the ply portions 302. Further, an axial distance in the axial direction Y between one reinforcing element 301 and an adjacent reinforcing element 301 may be different for different ones of the ply portions 302. A larger axial distance in the axial direction Y is shown for central ply portions 302 in the radial direction R than those ply portions 302 higher and lower in the radial direction R. Some ply portions 302 have more reinforcement elements 301 than others.

Furthermore, the NPT 100 of FIG. 19 discloses that the tread inner radial surface 203 may extend radially inward in the radial direction R into a ply portion 302 in which a reinforcing element 301 is not present. In this way, the outer radial surface 202 may also extend radially inward in the radial direction R, while maintaining the tread depth near the tread axial extent 204. This may enable a smaller circumference near the axial extents 204, while enabling improved off-road traction. Taken together, this may improve subjective rut wander performance.

FIG. 20 discloses an exemplary tread portion 210 near the axial extents of the annular beam 200. This portion 210 comprises tread blocks that extend along the axial direction Y. As such, bending stiffness is added in the R-Y plane, which may help to rigidify the annular beam 200 in this region. Further, reinforcing elements 301 near the axial extents 204 may extend completely in the circumferential direction Θ or diagonally so as to have components of extension in both the circumferential Θ and axial Y directions. This may enable a higher stiffness or increased stability of the axial extents of the annular beam 200, all the while enabling the tread 100 features disclosed in FIGS. 19 and 20.

Certain additional elements that may be needed for operation of some embodiments have not been described or illustrated as they are assumed to be within the purview of those of ordinary skill in the art. Moreover, certain embodiments may be free of, may lack and/or may function without any element that is not specifically disclosed herein.

Any feature of any embodiment discussed herein may be combined with any feature of any other embodiment discussed herein in some examples of implementation.

In case of any discrepancy, inconsistency, or other difference between terms used herein and terms used in any document incorporated by reference herein, meanings of the terms used herein are to prevail and be used.

Although various embodiments and examples have been presented, this was for the purpose of describing, but not limiting, the invention. Various modifications and enhancements will become apparent to those of ordinary skill in the art and are within the scope of the invention, which is defined by the appended claims.

1. A non-pneumatic tire, comprising:
a rim, wherein an axis extends through the rim in a lateral direction;
an annular support extending outward from the rim in a radial direction;
a tread having a surface, wherein the tread has a farthest outer axial extent that is located at a terminal end of the tread in the lateral direction; and
an annular beam located between the annular support and the tread in the radial direction, wherein the annular beam has a reinforcement portion that has a plurality of reinforcing elements, wherein the reinforcing element closest to the farthest outer axial extent in the lateral direction is at a width W1 to the farthest outer axial extent in the lateral direction, wherein W1 is at least 8 millimeters;
wherein the plurality of reinforcing elements are arranged in layers in the radial direction in the reinforcement portion;
wherein successive ones of the reinforcing elements in some of the layers are spaced a greater distance to one another in the lateral direction than spacing in the lateral direction between successive ones of the reinforcing elements to one another in different ones of the layers;
wherein the reinforcing element closest to the farthest outer axial extent in the lateral direction at the width W1 to the farthest outer axial extent in the lateral direction is one of the reinforcing elements of the layers that have the reinforcing elements spaced the greater distance in the lateral direction, and
wherein none of the reinforcing elements of the layers that have the reinforcing elements spaced the lesser distance in the lateral direction are spaced the width W1 to the farthest outer axial extent in the lateral direction.

2. The non-pneumatic tire as set forth in claim 1, wherein W1 is at least 16 millimeters.

3. The non-pneumatic tire as set forth in claim 1, wherein the annular beam has a plurality of wraps of a ply that extend in a circumferential direction of the non-pneumatic tire, wherein the plurality of reinforcing elements are located within the ply.

4. (canceled)

5. (canceled)

6. (canceled)

7. The non-pneumatic tire as set forth in claim 1, wherein the layers that have the reinforcing elements spaced the greater distance are located between the layers that have the reinforcing elements spaced a lesser distance.

8. (canceled)

9. The non-pneumatic tire as set forth in claim 1, wherein some of the layers have more of the reinforcing elements than other ones of the layers.

10. The non-pneumatic tire as set forth in claim 1, wherein the tread extends in the radial direction at the farthest outer axial extent so as to be located closer to the axis in the radial direction than at least some of the reinforcing elements are to the axis in the radial direction.

11. The non-pneumatic tire as set forth in claim 1, wherein the reinforcing elements are made of composite fibers.

12. The non-pneumatic tire as set forth in claim 1, wherein the tread has an axially central point P1 on the surface that is at a midpoint of the tread in the lateral direction;
wherein the tread has a point P2 on the surface that is located a distance d from the axially central point P1 in the lateral direction;
wherein the tread has a point P3 on the surface that is located at an axial extent of the tread, wherein the point P2 is between the axially central point P1 and the point P3 in the lateral direction;
wherein the surface has a circumference around the axis that is P1CIR at the axially central point P1, wherein the surface has a circumference around the axis that is P3CIR at the point P3;
wherein P3CIR is at least 50 millimeters less than P1CIR.

13. The non-pneumatic tire as set forth in claim 12, wherein P3CIR is at least 75 millimeters less than P1CIR.

14. The non-pneumatic tire as set forth in claim 12, wherein the distance d is at least 35 millimeters, and wherein the outer surface of the tread is convex from P1 to P3.

15. The non-pneumatic tire as set forth in claim 12, wherein the annular beam has an annular beam width in the lateral direction that is WB, wherein the surface of the tread is flat so as to have the same circumference around the axis along a length in the lateral direction that is at least 50% of the length of WB.
